(19) United States
(12) Patent Application Publication
(10) Pub. No.: US 2021/0140203 A1
(43) Pub. Date: May 13, 2021

(54) OVERRIDE OF CHILD SAFETY LOCK

(71) Applicant: GM GLOBAL TECHNOLOGY OPERATIONS LLC, Detroit, MI (US)

(72) Inventor: Joseph F. Szczerba, Grand Blanc, MI (US)

(21) Appl. No.: 16/676,784

(22) Filed: Nov. 7, 2019

(51) Int. Cl. E05B 77/26

(52) U.S. Cl. CPC E05B 77/26; E05Y 2400/854

(57) ABSTRACT

A vehicle door assembly includes a door latch configured to secure the vehicle door in a closed position, and an inside door handle assembly operably connected to the door latch and configured, when operated in a first door handle mode, to release the door latch thus allowing for movement of the vehicle door from the closed position. A lock post is operably connected to the door latch and configured, when operated in a first lock post mode, to lock the door latch. A child safety lock switch is operably connected to the door latch and configured such that, when activated, the child safety lock switch prevents releasing of the door latch via operation of the inside door handle in the first door handle mode. One or more of the inside door handle or the lock post operates in a second mode to deactivate the child safety lock switch.

### INTRODUCTION

The subject disclosure relates generally to vehicle doors, and in particular to child safety lock systems of vehicle doors.

Vehicle doors, especially vehicle rear doors are equipped with a lock system referred to as a child safety lock, that when engaged prevents opening of the door via normal activation of the door inside handle. This prevents opening of the door by a rear seat passenger, such as a child. The child safety lock may be engaged by, for example, a switch on the door, which is not accessible when the door is closed. Also, the child safety lock may be engaged or disengaged by a switch located at the driver's seat position, such as on the driver's door panel or on the instrument panel. This allows for engagement and/or disengagement of the child safety lock by the driver.

When adults ride in the rear seat, however, the child lock may be engaged and leave the adult with no way to open the rear door in an emergency situation. Accordingly, it would be desirable in the industry to provide an apparatus to override the child safety lock which can be used by an adult, but that would be difficult for a child to understand and use, thus preventing disengaging of the child safety lock by a child rear seat passenger.

### SUMMARY

In one embodiment, a vehicle door assembly includes a door latch configured to secure the vehicle door in a closed position, and an inside door handle assembly operably connected to the door latch and configured, when operated m a first door handle mode, to release the door latch thus allowing for movement of the vehicle door from the closed position toward an open position. A lock post is operably connected to the door latch and configured, when operated in a first lock post mode, to lock the door latch. A child safety lock switch is operably connected to the door latch and configured such that, when activated, the child safety lock switch prevents releasing of the door latch via operation of the inside door handle in the first door handle mode. One or more of the inside door handle or the lock post is configured for operation in a second mode wherein the second mode deactivates the child safety lock switch.

Additionally or alternatively, in this or other embodiments the second mode includes engaging a deactivation switch located at the inside door handle, and operating the inside door handle after engaging the deactivation switch.

Additionally or alternatively, in this or other embodiments operating the inside door handle includes one of pulling the inside door handle past a second door handle detent or pulling the inside door handle multiple times.

Additionally or alternatively, in this or other embodiments the deactivation switch is one of a button or a slider located at the inside door handle.

Additionally or alternatively, in this or other embodiments the second mode includes operating the lock post in a second lock post mode.

Additionally or alternatively, in this or other embodiments the second lock post mode includes pulling the lock post past a first lock post detent, and squeezing the lock post to enable pulling of the lock post upward past a second lock post detent.

Additionally or alternatively, in this or other embodiments the second lock post mode includes pulling the lock post past a second lock post detent, and turning the lock post about a lock post axis.

Additionally or alternatively, in this or other embodiments the second mode includes simultaneously operating the lock post in a second lock post mode and operating the inside door handle in a second inside door handle mode.

Additionally or alternatively, in this or other embodiments the second lock post mode includes one or more of touching the lock post, thereby activating a capacitance sensor disposed thereat or pulling the lock post upward past a second lock post detent.

Additionally or alternatively, in this or other embodiments the second inside door handle mode includes one or more of pulling the inside door handle past a second door handle detent or pulling the inside door handle multiple times.

In another embodiment, a method of deactivating a child safety lock switch of a vehicle door includes operating one or more of an inside door handle operably connected to a door latch of the vehicle door or a lock post operably connected to the door latch in a second mode different from a first, normal operating mode thereby deactivating the child safety lock switch.

Additionally or alternatively, in this or other embodiments the second mode includes engaging a deactivation switch located at the inside door handle, and operating the inside door handle after engaging the deactivation switch.

Additionally or alternatively, in this or other embodiments operating the inside door handle includes one of pulling the inside door handle past a second door handle detent or pulling the inside door handle multiple times.

Additionally or alternatively, in this or other embodiments the deactivation switch is one of a button or a slider located at the inside door handle.

Additionally or alternatively, m this or other embodiments the second mode includes operating the lock post in a second lock post mode.

Additionally or alternatively, in this or other embodiments the second lock post mode includes pulling the lock post past a first lock post detent, and squeezing the lock post to enable pulling of the lock post upward past a second lock post detent.

Additionally or alternatively, in this or other embodiments the second lock post mode includes pulling the lock post past a second lock post detent, and turning the lock post about a lock post axis

Additionally or alternatively, in this or other embodiments the second mode includes simultaneously operating the lock post in a second lock post mode and operating the inside door handle in a second inside door handle mode.

Additionally or alternatively, in this or other embodiments the second lock post mode includes one or more of touching the lock post, thereby activating a capacitance sensor disposed thereat, or pulling the lock post upward past a second lock post detent.

Additionally or alternatively, in this or other embodiments the second inside door handle mode includes one or more of pulling the inside door handle past a second door handle detent or pulling the inside door handle multiple times.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of a vehicle door from an interior of a vehicle;

FIG. 2 is a schematic illustration of a vehicle door from an exterior of a vehicle;

FIG. 3 is a schematic illustration of a child safety lock switch of a vehicle door;

FIG. 4 is a schematic illustration of an embodiment of a child safety lock override apparatus at an inside door handle;

FIG. 5 is another schematic illustration of an embodiment of a child safety lock override apparatus at an inside door handle;

FIG. 6 is a schematic illustration of an embodiment of a child safety lock override apparatus at an door lock post; and

FIG. 7 is another schematic illustration of an embodiment of a child safety lock override apparatus at a door lock post.

### DETAILED DESCRIPTION

The following description is merely exemplary in nature and is not intended to limit the present disclosure, its application or uses.

It should be understood that throughout the drawings, corresponding reference numerals indicate like or corresponding parts and features.

In accordance with an exemplary embodiment, FIG. 1 illustrates an embodiment of a vehicle door 10.

The vehicle door 10 illustrated is a rear passenger door. The vehicle door 10 includes an inner door panel 12 and an outer door panel 14 (shown best in FIG. 2) secured to the inner door panel 12 via, for example, welding. The vehicle door 10 may further include a window frame 16. The vehicle door 10 is located at a door opening 18 of a vehicle and is connected thereto via one or more door hinges 20 located at for example, a first end 22 of the vehicle door 10. In some embodiments, the first end 22 is a forward end of the vehicle door 10. The vehicle door 10 is movable between a closed position and an open position via the door hinges 20. A door latch 24 is located in the vehicle door 10 at, for example, a second end 26 of the vehicle door 10 opposite the first end 24. The vehicle door 10 is securable in the closed position via engagement of the door latch 24 with a door striker 50 located in the door opening 18.

Referring again to FIG. 2, an outer door handle 28 is located at the outer door panel 14 and is operatively connected to the door latch 24 such that when the outer door handle 28 is actuated by, for example, lifting, pulling or pushing, the door latch 24 disengages from the door striker 50 allowing for moving of the vehicle door 10 from a closed position toward an open position. The connection between the outer door handle 28 and the door latch 24 may be a mechanical connection via, for example, a linkage, or alternatively may be electrical.

Referring again to FIG. 1, the vehicle door 10 includes an inner door handle 30 located at the inner door panel 12. The inner door handle 30 is similarly operatively connected to the door latch 24 such that when the inner door handle 30 is normally actuated by, for example, pulling, the door latch 24 disengages from the door striker 50 allowing for moving of the vehicle door 10 from the closed position toward the open position. The connection between the inner door handle 30 and the door latch 24 may be a mechanical connection via, for example, a linkage, or alternatively may be electrical.

Referring now to FIG. 3, a child safety lock switch 32 is located at, for example, the inner door panel 12, and is operably connected to the door latch 24. When the child safety lock switch 32 is activated, it prevents release of the door striker 50 by the door latch 24 when the inner door handle 30 is normally actuated by pulling. When the child safety lock switch 32 is activated, the vehicle door 10 is openable by actuating the outer door handle 28. The child safety lock switch 32 is typically located at a portion of the inner door panel 12 inaccessible or unreachable when the vehicle door 10 is in the closed position.

In some instances, such as when an adult is seated in a rear seat of the vehicle and there is an emergency situation, it is desirable to allow for an override or deactivation of the child safety lock switch 32 to allow the vehicle door 10 to be opened by the adult for egress from the vehicle. Such an override may include a combination of actions or steps to deactivate the child safety lock switch 32 by the passenger.

An exemplary apparatus to deactivate or override the child safety lock switch 32 is illustrated in FIG. 4. In this embodiment, a deactivation switch 34 is located at an inner door handle trim 36, which surrounds the inner door handle 30. The deactivation switch 34 may take the form of, for example, a button or a slider, and may have one or more of a mechanical connection or an electrical connection to the child safety lock switch 32. As a first step, the user will engage the deactivation switch 34 by, for example, pushing the button or sliding the slider. Once the deactivation switch 34 is engaged, the user pulls the inner door handle 30, to complete deactivation of the child safety lock switch 32. In some embodiments, disengagement of the child safety lock switch 32 requires that the inner door handle 30 is pulled in a specific way. For example, the deactivation may require that the inner door handle 30 is pulled multiple times, for example, two, three or four times. Other embodiments may require pulling of the inner door handle 30 past a second door handle detent, where normal operation of the inner door handle 30 requires pulling the inner door handle 30 only past a first door handle detent.

Another embodiment is illustrated in FIG. 5. In the embodiment of FIG. 5, the deactivation switch 34 is located at the inner door handle 30. As with the embodiment of FIG. 4, the deactivation switch 34 may take the form of, for example, a button or a slider, and may have one or more of a mechanical connection or an electrical connection to the child safety lock switch 32. As a first step, the user will engage the deactivation switch 34 by, for example, pushing the button or sliding the slider. Once the deactivation switch 34 is engaged, the user pulls the inner door handle 30, to complete deactivation of the child safety lock switch 32. In some embodiments, disengagement of the child safety lock switch 32 requires that the inner door handle 30 is pulled in a specific way. For example, the deactivation may require that the inner door handle 30 is pulled multiple times, for example, two, three or four times. Other embodiments may require pulling of the inner door handle 30 past a second door handle detent, where normal operation of the inner door handle 30 requires pulling the inner door handle 30 only past a first door handle detent.

Another embodiment is illustrated in FIG. 6. The vehicle door 10 includes a lock post 52 at the inner door panel 12. During normal operation, the user pulls the lock post 52 upward to a first lock post detent 54, which normally unlocks the vehicle door 10 when the child safety lock switch 32 is not engaged. To utilize the lock post 52 to deactivate the child safety lock switch 32, the lock post 52 is first pulled upward past the first lock post detent 54. After pulling the lock post 52 past the first lock post detent 54, post sides 56 of the lock post 52 are squeezed toward one another to allow the lock post 52 to be pulled further past the first detent 54 and past a second lock post detent 58. Pulling the lock post 52 past the second lock post detent 58 deactivates the child safety lock switch 32, and allows the vehicle door 10 to be moved from the closed position toward an open position. Referring now to FIG. 7, in another embodiment the child safety lock switch 32 is deactivated by first pulling the lock post 52 past the second lock post detent 58 then by twisting or turning the lock post 52 about a lock post central axis 62.

In some embodiments, deactivating the child safety lock switch 32 requires two simultaneous actions at two components. For example, in one embodiment the lock post 52 is touched to activate a capacitance sensor 64 at the lock post 52. Simultaneously, the inner door handle 30 is pulled past the second door handle detent, or multiple pulls past the first door handle detent, to deactivate the child safety lock switch 32. In another embodiment, the lock post 52 is pulled up past the second lock post detent 58 while the inner door handle 30 is simultaneously pulled past the second door handle detent, or multiple pulls past the first door handle detent.

The embodiments disclosed herein provide apparatus and methods of overriding or deactivating the child safety lock switch 32, allowing for egress from the vehicle 10 when the child safety lock switch 32 has been engaged. The two-step processes, however, are difficult or non-intuitive for a child, so that a child typically will not be able to deactivate the child safety lock switch 32.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle door assembly, comprising:
a door latch configured to secure the vehicle door in a closed position;
an inside door handle assembly operably connected to the door latch and configured, when operated in a first door handle mode, to release the door latch thus allowing for movement of the vehicle door from the closed position toward an open position;
a lock post operably connected to the door latch and configured, when operated in a first lock post mode, to lock the door latch;
a child safety lock switch operably connected to the door latch and configured such that, when activated, the child safety lock switch prevents releasing of the door latch via operation of the inside door handle in the first door handle mode;
wherein one or more of the inside door handle or the lock post is configured for operation in a second mode wherein the second mode deactivates the child safety lock switch.

2. The vehicle door assembly of claim 1, wherein the second mode includes:
engaging a deactivation switch disposed at the inside door handle; and
operating the inside door handle after engaging the deactivation switch.

3. The vehicle door assembly of claim 2, wherein operating the inside door handle includes one of pulling the inside door handle past a second door handle detent or pulling the inside door handle multiple times.

4. The vehicle door assembly of claim 2, wherein the deactivation switch is one of a button or a slider disposed at the inside door handle.

5. The vehicle door assembly of claim 1, wherein the second mode includes operating the lock post in a second lock post mode.

6. The vehicle door assembly of claim 5, wherein the second lock post mode includes:
pulling the lock post past a first lock post detent; and
squeezing the lock post to enable pulling of the lock post upward past a second lock post detent.

7. The vehicle door assembly of claim 5, wherein the second lock post mode includes:
pulling the lock post past a second lock post detent; and
turning the lock post about a lock post axis.

8. The vehicle door assembly of claim 1, wherein the second mode includes simultaneously operating the lock post in a second lock post mode and operating the inside door handle in a second inside door handle mode.

9. The vehicle door assembly of claim 8, wherein the second lock post mode includes one or more of:
touching the lock post, thereby activating a capacitance sensor disposed thereat; or
pulling the lock post upward past a second lock post detent.

10. The vehicle door assembly of claim 8, wherein the second inside door handle mode includes one or more of pulling the inside door handle past a second door handle detent or pulling the inside door handle multiple times.

11. A method of deactivating a child safety lock switch of a vehicle door, comprising operating one or more of an inside door handle operably connected to a door latch of the vehicle door or a lock post operably connected to the door latch in a second mode different from a first, normal operating mode thereby deactivating the child safety lock switch.

12. The method of claim 11, wherein the second mode includes:
engaging a deactivation switch disposed at the inside door handle; and
operating the inside door handle after engaging the deactivation switch.

13. The method of claim 12, wherein operating the inside door handle includes one of pulling the inside door handle past a second door handle detent or pulling the inside door handle multiple times.

14. The method of claim 12, wherein the deactivation switch is one of a button or a slider disposed at the inside door handle.

15. The method of claim 11, wherein the second mode includes operating the lock post in a second lock post mode.

16. The method of claim 15, wherein the second lock post mode includes:
pulling the lock post past a first lock post detent; and
squeezing the lock post to enable pulling of the lock post upward past a second lock post detent.

17. The method of claim 15, wherein the second lock post mode includes:
pulling the lock post past a second lock post detent; and
turning the lock post about a lock post axis.

18. The method of claim 11, wherein the second mode includes simultaneously operating the lock post in a second lock post mode and operating the inside door handle in a second inside door handle mode.

19. The method of claim 18, wherein the second lock post mode includes one or more of:
touching the lock post, thereby activating a capacitance sensor disposed thereat; or
pulling the lock post upward past a second lock post detent.

20. The method of claim 18, wherein the second inside door handle mode includes one or more of pulling the inside door handle past a second door handle detent or pulling the inside door handle multiple times.
